(19) United States
(12) Patent Application Publication
(10) Pub. No.: US 2009/0305583 A1
(43) Pub. Date: Dec. 10, 2009

(54) ELECTRICAL CONTACT PIN

(75) Inventor: William D. IRWIN, Elizabethtown, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/135,255

(22) Filed: Jun. 9, 2008

(51) Int. Cl. H01R 13/02; H01R 43/04

(52) U.S. Cl. 439/884; 29/881

(57) ABSTRACT

Provided is a contact pin with a solder cup. The solder cup is formed directly from the contact pin by a manufacturing process. The manufacturing process includes the steps of providing a wire, securing the wire in a carrier structure, cutting the wire to a predetermined length to form a contact, coining a first end of the contact to a predetermined thickness and forming the first end of the contact into a solder cup.

### FIELD OF THE INVENTION

The present invention is directed to electrical contact pins. More specifically, the present invention is directed to a method and system for manufacturing an electrical contact pin having a solder cup.

### BACKGROUND OF THE INVENTION

Solder cups are commonly used with contact pins for electrical applications. Solder cups provide a means for applying solder and securing the contact pin to a wire that allows connection to an electrical device or other suitable device or component. Solder cups may be manufactured directly from an end of the contact pin by a machining process. The machining process to form the solder cup from the contact pin is time consuming and undesirable waste is generated from the material removed from the contact pin to form the solder cup. Solder cups may also be manufactured by stamping flat material into a predetermined shape and rolling it into a round pin. This process involves the removal of significant amounts of material during manufacturing. These known manufacturing methods are inefficient and costly.

Thus, there is an ongoing need for an efficient and low cost manufacturing process for manufacturing a contact pin having a solder cup. What is further needed is a manufacturing process that generates little or no waste when forming or manufacturing the solder cup.

### SUMMARY OF THE INVENTION

The present invention is directed to a method for manufacturing an electrical contact having a solder cup. The method includes the steps of providing a wire, securing the wire in a carrier structure, cutting the wire to a predetermined length to form a contact and forming the first end of the contact into a solder cup.

The present invention is also directed to a method for manufacturing an electrical contact having a solder cup. The method includes the steps of providing wire on a carrier structure, cutting the wire to a predetermined length to form a contact, repeating the step of cutting the wire to a predetermined length to form a contact until the desired number of contacts are formed, and forming a first end of each contact of the plurality of contacts into a solder cup.

The present invention is further directed to an electrical contact with a solder cup manufactured by a process. The process includes the steps of providing a wire, securing the wire in a carrier structure, and cutting the wire to a predetermined length to form a contact. The process also includes the steps of coining a first end of the contact to a predetermined thickness and forming the first end of the contact into a solder cup.

An advantage of the present invention is a solder cup formed on the end of an electrical contact pin by a manufacturing process that generates minimal waste.

Another advantage of the present invention is that the contact pin is disposed on a carrier, and the solder cup is formed from the contact pin, thereby providing a means for automated manufacturing.

Yet another advantage of the present invention is the solder cup may be coated with a tin coating or other suitable coating without coating the remaining portion of the contact pin.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 shows a plan view of an apparatus forming electrical contact pins according to an embodiment of the disclosure.

FIG. 2 shows an enlarged view of the apparatus in FIG. 1.

FIG. 3 shows an enlarged view of the apparatus forming the solder cups on an end of the contact pins in FIG. 2.

FIG. 4 shows an enlarged view of an electrical contact pin according to an embodiment of the disclosure.

Wherever possible, the same reference numbers will be used throughout the drawings to refer to the same or like parts.

### DETAILED DESCRIPTION OF THE INVENTION

Exemplary embodiments of the present invention are now described with reference to the figures. Reference numerals are used throughout the detailed description to refer to the various elements and structures. In other instances, well-known structures and devices are shown in block diagram form for purposes of simplifying the description. Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

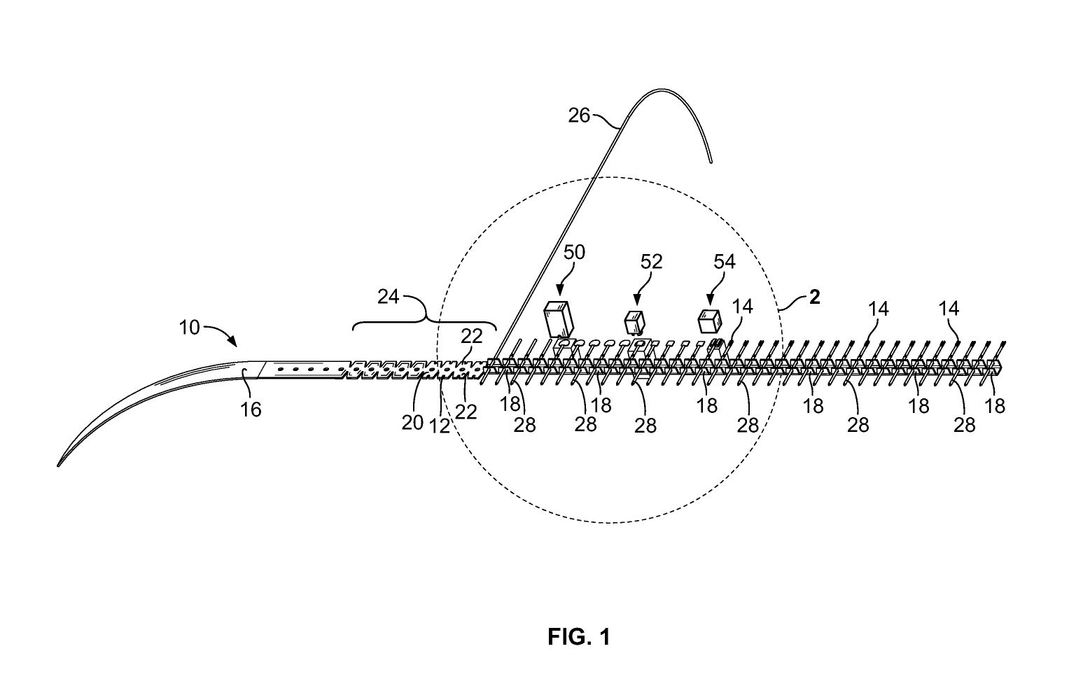

FIG. 1. shows a carrier 10 with contact pins 28 having solder cups 14 formed on one end. Carrier 10 is formed from a strip of material 16, such as metal (e.g. brass or steel) or other suitable material. Carrier sections 24 may be formed by a stamping process, where material 16 is stamped into a predetermined shape 20, and the edges 22 of predetermined shape 20 are bent or formed upward to form a carrier structure 18. Predetermined shape 20 may include slots 12 or other suitable receivers for accepting and securing contact pins 28 once contact pins 28 are inserted into carrier structure 24. A wire strip 26 from a reel (not shown) or other suitable source is advanced into a carrier structure 18, and wire strip 26 is cut to a predetermined length to form a contact pin 28. Contact pin 28 is formed from wire strip 26 by cutting the wire strip 26 to a predetermined length. The remaining portion of wire strip 26 is advanced into the next carrier structure 18, and then is cut to the same predetermined length to form a second contact pin 28 secured in carrier structure 18. The process of forming contact pins 28 is repeated until the desired number of contact pins 28 are formed.

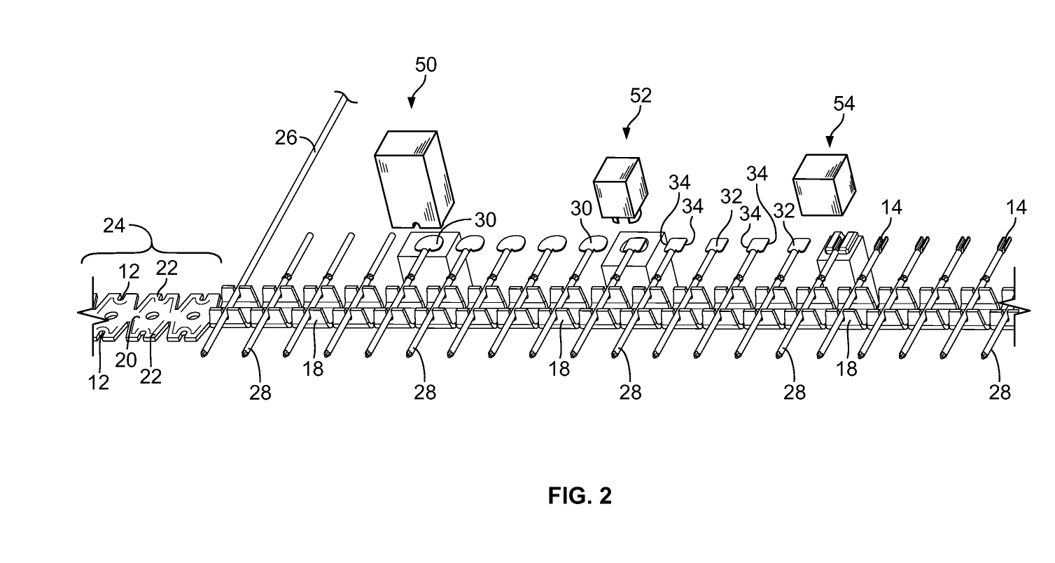

Referring now to FIG. 2, once contact pin 28 is cut to the predetermined length and secured in carrier structure 18, one end of contact pin 28 is coined to a predetermined thickness by a coining process 50. Coined edge 30 may be trimmed to a predetermined shape 32 with predetermined dimensions by a trimming process 52. Predetermined shape 32 may be for example, a rectangular configuration, and more specifically, a square configuration. While a rectangular configuration is described, it is appreciated that any suitable predetermined shape may be used. Next, predetermined shape 32 is formed into a solder cup 14, by having the edges 34 of predetermined shape 32 folded or formed upward during a forming process 54. When edges 34 are formed upward during forming process 54, a “U” shaped configuration is formed. While FIG. 2 shows solder cup 14 being manufactured by a three step process including coining process 50, trimming process 52, and forming process 54, it is known that solder cup 14 may be formed by a two step process including coining process 50 and forming process 54.

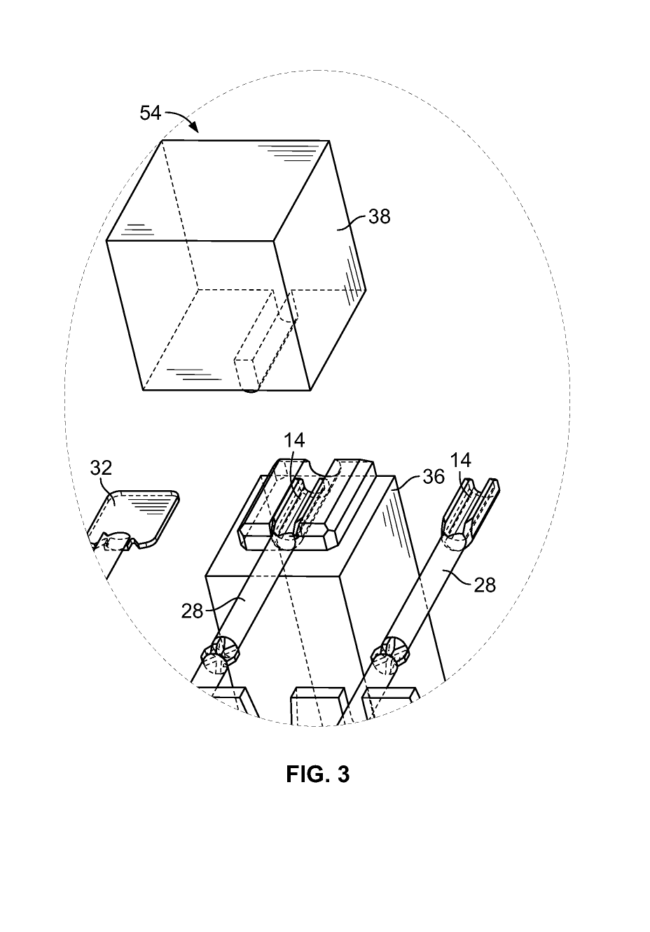

FIG. 3 shows an enlarged view of the forming process 54 of solder cup 14 on the end of contact pin 28. A coined and trimmed contact pin 28 is formed into solder cup 14. A bottom form 36 presses into the underside or bottom side of predetermined shape 32 of coined and trimmed contact pin 28. A top form 38 presses into the topside of predetermined shape 32 of coined and trimmed contact 28 substantially simultaneously with bottom form 36. As top form 38 and bottom form 36 meet as they press into predetermined shape 32 of contact pin 28, predetermined shape 32 is formed into solder cup 14. When solder cup 14 is formed, little or no waste is generated. It is appreciated that bottom form 36 and top form 38 may form solder cup 14 from contact pin 28 after coining process 50, and without trimming process 52. It is also appreciated that bottom form 36 and top form 38 may form solder cup 14 from contact pin 28 without the coining process 50 and the trimming process 52.

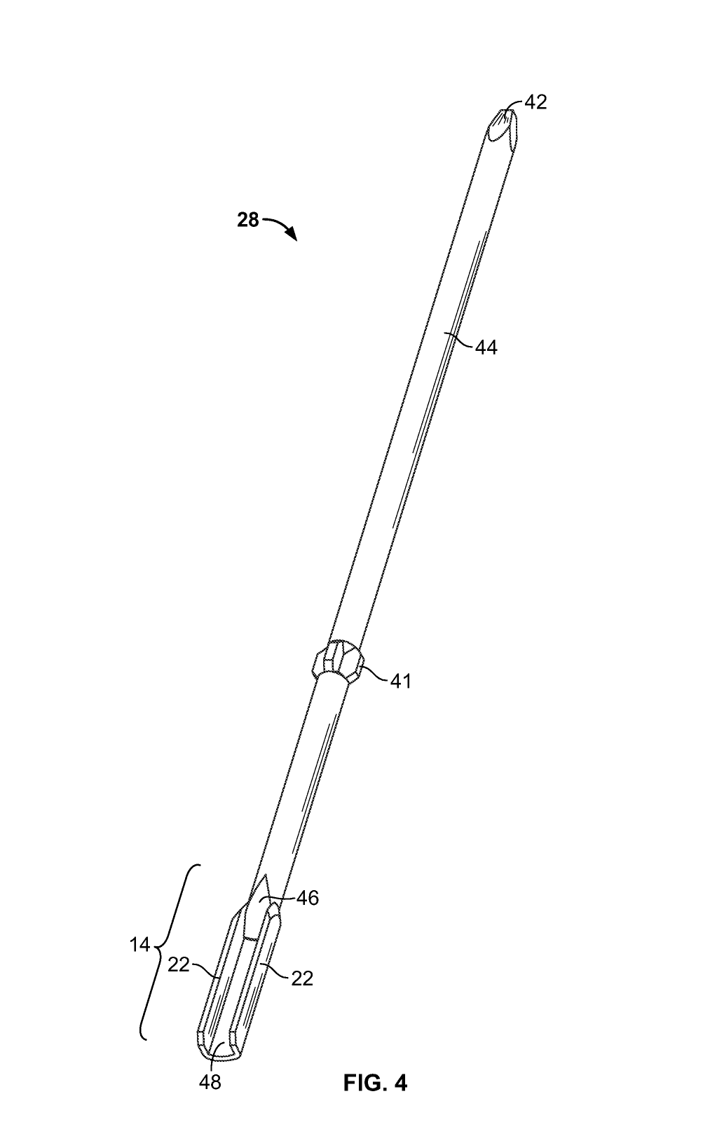

FIG. 4 shows an enlarged view of contact pin 28 with solder cup 14 formed on one end. On the opposite end of contact pin 28, a tip 42 is formed, having no sharp edges, but being formed with tapered surfaces. Tip 42 may be formed when contact pin 28 is cut from wire strip 26 (FIG. 1), or tip 42 may be formed by a separate forming or trimming process. Zone 44 is the portion of contact pin 28 that is placed and secured in carrier structure 24 (FIG. 1) of carrier 10 (FIG. 1). Disposed on contact pin 28 substantially near the bottom of zone 44 is a retention feature 41. Retention feature 41 facilitates a secure retention of contact pin 28 in a suitable device in which contact pin 28 is inserted for use after manufacture.

A transition zone 46 connects solder cup 14 to contact pin 28. Transition zone 46 is a tapered surface that gradually tapers from contact pin 28 to the base 48 of solder cup 14. While any suitable dimensions may be used, solder cup may be 2.35 mm in length and 0.45 mm in height. When coined, contact pin 28 may have a thickness of 0.2 mm thick and solder cup may be 0.65±0.04 mm wide when formed. Wire 26 (FIG. 1) may be a pre-plated material or wire 26 may be unplated when solder cup 14 is formed. Unplated pins 28 may then be plated with materials (e.g. nickel, then gold) across the entire pin 28. Conversely, they may be entirely plated with a material (e.g. nickel). Plating suited for the function of each area may be applied only to those areas. For example, solder cup 14 may be plated with a material (e.g. tin) that would facilitate soldering of a wire. An area extending back from tip 42 could be plated with a different material (e.g. gold) in the area intended as a separable interface. Using multiple platings provides the best finish for the application of each end of the pin and helps control cost. The manufacturing process for the contact pin 28 with solder cup 14 may facilitate a process in which greater than on thousand contact pins 28 with solder cups 14 may be formed in one minute. It is also appreciated that less than one thousand contact pins may be formed per each minute, if desired.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the Applicant's general inventive concept.

1. A method for manufacturing an electrical contact having a solder cup comprising the steps of:
providing a wire;
securing the wire in a carrier structure;
cutting the wire to a predetermined length to form a contact; and
forming the first end of the contact into a solder cup.

2. The method of claim 1, comprising the step of coining a first end of the contact to a predetermined thickness.

3. The method of claim 2, wherein the step of coining a first end of the contact to a predetermined thickness comprises flattening the first end of the contact.

4. The method of claim 2, comprising the step of trimming the first end of the contact to a predetermined shape.

5. The method of claim 4, wherein the predetermined shape is a rectangular geometry.

6. The method of claim 4, wherein the predetermined shape is a square geometry.

7. The method of claim 4, wherein the step of forming the first end of the contact into a solder cup further comprises bending opposite sides of the contact upward to form a “U” shape.

8. The method of claim 1, wherein the step of cutting the wire to a predetermined length to form a contact is repeated to form a plurality of contacts.

9. The method of claim 1, wherein the step of forming the first end of the contact into a solder cup uses substantially all of the material from the first end.

10. A method for manufacturing an electrical contact having a solder cup comprising the steps of:
providing wire on a carrier structure;
cutting the wire to a predetermined length to form a contact;
repeating the step of cutting the wire to a predetermined length to form a contact until the desired number of contacts are formed; and
forming a first end of each contact of the plurality of contacts into a solder cup.

11. The method of claim 10, further comprising the step of coining a first end of each contact to a predetermined thickness.

12. The method of claim 11, further comprising the step of trimming the first end of each contact to a predetermined shape.

13. The method of claim 11, wherein the step of coining a first end of each contact to a predetermined thickness comprises flattening the first end of each contact.

14. The method of claim 12, wherein the predetermined shape is a rectangular geometry.

15. The method of claim 12, wherein the predetermined shape is a square geometry.

16. The method of claim 12, wherein the step of forming the first end of each contact into a solder cup further comprises bending opposite sides of the coined and trimmed contact upward to form a “U” shape.

17. The method of claim 10, wherein the step of forming the first end of the contact into a solder cup uses substantially all of the material from the first end.

18. An electrical contact with a solder cup manufactured by the process comprising the steps of:
providing a wire;
securing the wire in a carrier structure;
cutting the wire to a predetermined length to form a contact;
coining a first end of the contact to a predetermined thickness; and
forming the first end of the contact into a solder cup.

19. The electrical contact of claim 18, wherein the process comprises the step of trimming the first end of the contact to a predetermined shape.

20. The electrical contact of claim 18, wherein the step of cutting the wire to a predetermined length to form a contact is repeated to form a plurality of contacts.
